(19) United States
(12) Patent Application Publication
(10) Pub. No.: US 2014/0335316 A1
(43) Pub. Date: Nov. 13, 2014

(54) DISPLAY PANEL WITH FRONT PLATE, AND DISPLAY DEVICE

(71) Applicant: Sharp Kabushiki Kaisha, Osaka-shi, Osaka (JP)

(72) Inventors: Hiroshi Fukushima, Osaka-shi (JP); Tomoo Takatani, Osaka-shi (JP)

(21) Appl. No.: 14/364,094

(22) PCT Filed: Dec. 5, 2012
(86) PCT No.: PCT/JP2012/081461

§ 371 Date: Jun. 10, 2014

(30) Foreign Application Priority Data
Dec. 13, 2011 (JP) 2011-272543

(51) Int. Cl. G02F 1/1333; B32B 7/12

(52) U.S. Cl. CPC G02F 1/133308; B32B 7/12; G02F 2001/13332; G02F 2001/133334; B32B 2250/03; B32B 2457/202
USPC 428/161

(57) ABSTRACT

The present invention provides a display panel with a front plate and a display device which exhibit improved display qualities with suppressed air bubbles and display unevenness in and around a display region, and sufficiently suppress peeling of the front plate from the display panel. The display panel with a front plate of the present invention includes: a display panel; a front plate; an adhesive layer disposed between the front plate and the display panel; and a patterned layer further disposed between the front plate and the display panel, the adhesive layer partly overlapping the patterned layer in a plan view of a main surface of the display panel with a front plate, a thickness of the adhesive layer in a region overlapping the patterned layer being smaller than a thickness of the adhesive layer in a region not overlapping the patterned layer, the adhesive layer having a lower elastic modulus in the region overlapping the patterned layer than in the region not overlapping the patterned layer, the patterned layer including a light-shielding layer.

### TECHNICAL FIELD

The present invention relates to a display panel with a front plate, and a display device. More specifically, the present invention relates to a display panel with a front plate which includes a plate of, for example, glass or plastic, or a touch panel provided on the front surface of the display, from the standpoint of design and protection of the display surface; and a display device.

### BACKGROUND ART

Displays (display devices) including a display panel such as a liquid crystal panel have been indispensable to various fields including business and households. Especially, medium-to-small-sized displays have been developed and put into practical use for devices such as tablets, cell phones, and game machines. For recent cell phones such as smart phones, the design is especially important. Accordingly, there are a wide variety of print colors for decorative covers for protecting surfaces of liquid crystal display devices. Also, since interactivity, as well as display, has been important for these displays in recent years, an increasing number of these displays include a touch panel on the front surface thereof.

One example of display panels with a front plate is an electrical-optical device disclosed in Patent Literature 1, which includes an electrical-optical panel having an effective display region; a light-transmissive protective plate that protects the electrical-optical panel from external force; a colored layer formed outside the effective display region on the light-transmissive protective plate; and a pressure-sensitive adhesive disposed in a region overlapping the effective display region and part of the colored layer in a plan view, between and in close contact with the electrical-optical panel and the light-transmissive protective plate, wherein a first light-shielding layer is disposed in a region where the colored layer and the pressure-sensitive adhesive do not overlap in a plan view on the electrical-optical panel-side surface of the light-transmissive protective plate.

### CITATION LIST

### Patent Literature

Patent Literature 1: JP 2009-251550 A

### SUMMARY OF INVENTION

### Technical Problem

As described above, recent cell phones such as smart phones are those especially design-focused ones. Hence, there are various print colors for decorative covers, including white which is preferably printed in at least two layers, as well as black. With these various colors, the thickness of a printed portion for decoration has been increasing. Particularly, pale, bright colors are likely to transmit light, and thus are preferably printed in layers as described above. As a result, the thickness of the printed portion tends to increase.

FIG. 7 is a schematic cross-sectional view of a conventional liquid crystal display panel with a front plate. If a protective cover 428 to which a printed layer 426 is attached with a pressure-sensitive adhesive is attached to the entire surface of the liquid crystal display panel 450 with a sheet-form pressure-sensitive adhesive (a pressure-sensitive adhesive layer 424) (typically, transparent double-sided tape), there have been problems in the quality and the yield, including formation of air bubbles in the level difference portion formed by the printed portion (indicated by the dotted line in FIG. 7) and occurrence of display unevenness in the liquid crystal display device. These problems are more likely to arise when, for example, the printed layer 426 has a greater thickness or the pressure-sensitive adhesive layer 424 has a smaller thickness.

The causes of the air bubbles or display unevenness are described below. That is, in a case where a conventional sheet-form pressure-sensitive adhesive has a form with inferior flowability than a liquid adhesive, if there is a greater level difference portion caused by printing, such a pressure-sensitive adhesive cannot sufficiently deform to conform to the level difference because of its inferior flowability, and therefore causes formation of air bubbles in the portion. Even if the pressure-sensitive adhesive successfully conforms to the level difference to give no air bubbles, its insufficient flowability and deformability unfortunately put extra stress on the liquid crystal panel to cause display unevenness. In other words, the pressure-sensitive adhesive not being able to deform sufficiently causes the polarizing plate and the transparent electrode substrate to bend away from each other, and thereby induces cell-thickness unevenness.

This problem can be handled by imparting a low elastic modulus to the pressure-sensitive adhesive (i.e., making it soft) in order to reduce air bubbles and display unevenness. Generally, however, the adhesion decreases as the elastic modulus decreases. Also, the elastic modulus further decreases at high temperatures to lead to lower adhesion. This means that using only pressure-sensitive adhesives having a low elastic modulus in a conventional manner causes, unfortunately, peeling and formation of new air bubbles.

FIG. 8 is a schematic cross-sectional view of a liquid crystal display device with a front plate which is disclosed in Patent Literature 1.

In the display device of Patent Literature 1, a decorative cover 528 is attached entirely to a liquid crystal display panel 550 with a pressure-sensitive adhesive layer 524. The decorative cover 528 includes a color printed layer 526c and a light-shielding printed layer 526s. The ends of the pressure-sensitive adhesive layer 524 do not overlap the light-shielding printed layer 526s of the decorative cover 528. Also, a light-shielding portion 530s is formed in the liquid crystal display panel 550 to overlap the color printed layer 526c of the decorative cover 528 in a plan view. With this structure, formation of air bubbles due to the level differences in a conventional liquid crystal display panel with a front plate as illustrated in FIG. 7 can be prevented. Also, blocking the light (a) from a backlight unit 540 with the light-shielding portion 530s inside the liquid crystal display panel 550 probably prevents light transmission through the color printed portion of the decorative cover.

With the light-shielding portion 530s inside the liquid crystal display panel 550, the light (a) traveling in the forward direction from the backlight unit 540 as illustrated in FIG. 8 can be prevented from passing through the color printed layer 526c. However, light (b) traveling in oblique directions as illustrated in FIG. 8 cannot be blocked with the light-shielding portion 530s inside the liquid crystal display panel 550, and the light may be able to pass through the color printed layer 526c which has a low light-shielding ability. Here, although not illustrated in FIG. 8, if the light-shielding printed layer 526s is covered with the pressure-sensitive adhesive layer 524, the level difference formed by the printed portion increases to inhibit the pressure-sensitive adhesive constituting the pressure-sensitive adhesive layer from absorbing the influence of the level difference. As a result, air bubbles and display unevenness may occur in the level difference portion.

The present invention has been made in view of the above state of the art, and aims to provide a display panel with a front plate and a display device which exhibit improved display qualities with suppressed air bubbles and display unevenness in and around the display region and sufficiently suppress peeling of the front plate from the display panel.

### Solution to Problem

The present inventors have made various studies on structures for reducing air bubbles and display unevenness and suppressing peeling of the front plate from the display panel, for display panels with a front plate which includes an adhesive layer (e.g., a cured product of an ultraviolet-curable resin composition) between the front plate and the display panel, and display devices including such a display panel. As a result, the present inventors have focused on providing suitable elastic moduli to respective regions of the adhesive layer. Specifically, as illustrated in FIG. 4, the elastic modulus in a region R(I) of the pressure-sensitive adhesive layer 124, which is desired to deform by absorbing the influence of the thickness of the level difference formed by a patterned layer 126 (e.g., printed layer), is set lower than the elastic modulus in a region R(II) of the pressure-sensitive adhesive layer 124 which is not required to deform as much. The present inventors have therefore found that, as described above, the ability of absorbing the level difference can be increased by imparting a comparatively low elastic modulus to the region R(I) of the pressure-sensitive adhesive layer 124, and that the adhesion can be achieved especially at high temperatures by imparting a comparatively high elastic modulus to the region R(II) of the pressure-sensitive adhesive layer 124.

Generally, for example in the case of an ultraviolet-curable pressure-sensitive adhesive, there is a correlation between the degree of curing and the elastic modulus that the elastic modulus tends to increase as the degree of curing increases.

Specifically, for example, the case is considered in which bonding is performed using an ultraviolet-curable pressure-sensitive adhesive (e.g., acrylic-based pressure-sensitive adhesive) which has a degree of curing of 70% or lower, and then the adhesive is irradiated with ultraviolet light sufficiently from the decorative cover side. In this case, the bonding using the pressure-sensitive adhesive can be done without formation of air bubbles in the level difference portion, and then the degree of curing in the region R(II) of the pressure-sensitive adhesive layer can be made higher than that in the region R(I). Thus, no air bubbles remain upon completion of the bonding, and also high reliability at high temperatures can be achieved.

The elastic modulus (softness) of the pressure-sensitive adhesive for a window portion 128w (region without the patterned layer 216 such as a printed layer) in a front plate 128 (e.g., decorative cover) and the elastic modulus of the pressure-sensitive adhesive for a printed region 128p under the patterned layer 126 are different from each other, and the elastic modulus of the pressure-sensitive adhesive under the patterned layer 126 is lower than the elastic modulus of the pressure-sensitive adhesive for the window portion 128w. With this structure, it is possible to sufficiently prevent formation of air bubbles caused by the level difference formed by the printed portion.

In the region in which bonding with the pressure-sensitive adhesive layer 124 is performed, the patterned layer 126 of the front plate 128 includes both a color printed layer and a light-shielding printed layer so that the patterned layer 126 with a light-shielding layer is provided between the front plate 128 and the liquid crystal display panel 150. It is thereby possible to minimize the region with only a color printed layer, preventing the light transmission through the paths (b) as in the case of the technique of Patent Literature 1.

As described above, the present inventors have found that the display panel with a front plate and the display device including the display panel according to the present invention exhibit reduced air bubbles and display unevenness, and sufficiently prevent peeling of the front plate, thereby successfully solving the above problems. Accordingly, the present invention has been completed.

That is, the present invention relates to a display panel with a front plate, including: a display panel; a front plate; an adhesive layer disposed between the front plate and the display panel; and a patterned layer further disposed between the front plate and the display panel, the adhesive layer partly overlapping the patterned layer in a plan view of a main surface of the display panel with a front plate, a thickness of the adhesive layer in a region overlapping the patterned layer being smaller than a thickness of the adhesive layer in a region not overlapping the patterned layer, the adhesive layer having a lower elastic modulus in the region overlapping the patterned layer than in the region not overlapping the patterned layer, the patterned layer including a light-shielding layer.

Here, what is meant by “the adhesive layer having a lower elastic modulus in the region overlapping the patterned layer than in the region not overlapping the patterned layer” may be that the average of the elastic moduli of the adhesive layer in the region overlapping the patterned layer is lower than the average of the elastic moduli of the adhesive layer in the region not overlapping the patterned layer. Preferably, the elastic moduli of the adhesive layer in the region overlapping the patterned layer are substantially constant, and also the elastic moduli of the adhesive layer in the region not overlapping the patterned layer are substantially constant. Here, the elastic moduli of the adhesive layer in the region overlapping the patterned layer are preferably lower than the elastic moduli of the adhesive layer not overlapping the patterned layer.

Preferably, when d(ink) indicates a thickness of the patterned layer and d(OCA) indicates the thickness of the adhesive layer in the region not overlapping the patterned layer, the following inequality holds: d(ink)<d(OA)/2. In this way, if the thickness d(ink) of the patterned layer is smaller than the half the thickness d(OCA) of the adhesive layer in the region not overlapping the patterned layer, air bubbles and display unevenness in the bonding can be more sufficiently reduced.

The thickness d(ink) of the patterned layer in the display panel with a front plate according to the present invention is preferably 20 μm or greater. The upper limit for the thickness is preferably, for example, 75 μm or smaller. The patterned layer may be a single- or multi-layer, but is preferably a multi-layer to sufficiently achieve the effect of the present invention.

The thickness d(OCA) of the adhesive layer in the region not overlapping the patterned layer in the display panel with a front plate according to the present invention is preferably 80 μm or greater, more preferably 100 μm or greater, and still more preferably 120 μm or greater.

The patterned layer in the display panel with a front plate according to the present invention is preferably a laminate of the light-shielding layer and a colored layer. Here, the laminate of a light-shielding layer and a colored layer may be a laminate of multiple light-shielding layers and/or multiple colored layers. More preferred is a laminate of a single light-shielding layer and a single or multiple colored layers, for example.

The patterned layer in the display panel with a front plate according to the present invention is preferably disposed in a part of the same layer as the adhesive layer. More preferably, the patterned layer is disposed on the front plate side in the same layer as the adhesive layer. What is meant by being “disposed in the same layer” is, for example, being in contact with the same component (e.g., front plate, polarizing plate, insulating layer) on the liquid crystal layer side and/or the opposite side of the liquid crystal layer side.

The patterned layer is preferably a printed layer. Suitable examples of the printed layer include those formed by a typical screen printing or inkjet printing.

The adhesive layer in the display panel with a front plate according to the present invention may be any adhesive layer capable of making the front plate adhere, but is preferably a cured product of an ultraviolet-curable resin composition. In this case, the adhesive layer in the present invention can be appropriately formed by simply irradiating with ultraviolet light from the front plate side.

The cured product of an ultraviolet-curable resin composition is preferably formed from a resin composition that contains monomer components. The cured product of an ultraviolet-curable resin composition is used to fill a gap between the front plate and the display panel, or to attach the front plate to the display panel through adhesion or pressure-sensitive adhesion. The resin composition for forming a cured product of an ultraviolet-curable resin composition may contain monomers and oligomers. The resin composition may also contain a plasticizer.

The monomers may be a single or multiple species of (meth)acrylate-based monomers and/or silicon-based monomers.

The oligomers each are a dimer or greater polymer consisting of a single or multiple monomer units. Examples of the oligomers include those typically used as oligomers together with monomers in a resin composition for optical use, such as oligomers with a weight-average molecular weight of 500 to 100000.

The above resin composition may contain polymers as well as oligomers and monomers.

The adhesive layer is preferably formed by curing an ultraviolet-curable composition through photopolymerization by ultraviolet light irradiation, but may be formed by curing a resin composition through thermal polymerization, another kind of photopolymerization, or electron beam polymerization, for example. Usually, a polymerization initiator is used. The polymerization initiator may be, for example in the case of photopolymerization through ultraviolet light irradiation, a photopolymerization initiator such as a benzophenone-based compound, an anthraquinone-based compound, a benzoin-based compound, a sulfonium salt, a diazonium salt, or an onium salt. The amount of the polymerization initiator based on 100% by mass of the resin composition is preferably 0.01 to 10% by mass, more preferably 0.1 to 7% by mass, and still more preferably 1 to 5% by mass.

In the display panel with a front plate according to the present invention, it is preferred that the cured product has a degree of curing of 70% or lower in the region overlapping the patterned layer, and the cured product has a degree of curing of 80% or higher in the region not overlapping the patterned layer.

The elastic modulus can be determined by measuring the dynamic viscoelasticity at 25° C. and 1 Hz in accordance with JIS K7244-6. The measurement can be performed with, for example, a dynamic viscoelasticity measuring device (DVA-225 manufactured by IT Keisoku Seigyo K.K.).

The display panel with a front plate according to the present invention preferably further includes a touch panel. Here, the touch panel may be the front plate serving as a touch panel, or may be a separate touch panel provided in addition to the front plate.

The adhesive layer in the present invention is formed between the front plate and the display panel usually by performing application of or filling with a resin composition, and then bonding the front plate and the display panel, and thereafter curing the resin composition to form a layer of the cured product of the resin composition. The present invention is suitable for an embodiment in which the resin composition is applied to the front plate and/or the display panel or charged into the gap between the front plate and the display panel, and then the resin composition is cured.

Also, a layer of the cured product of a resin composition may be formed by, for example, sandwiching a cured product of a resin composition in the sheet form (also referred to as a sheet-form resin or pressure-sensitive adhesive sheet) between the front plate and the display panel.

In the case of performing application of or filling with the resin composition, it is common to apply the resin composition to one or both of the attachment surface of the front plate and the attachment surface of the display panel, bond the front plate and the display panel via the resin composition, and cure the resin composition with UV light. In the case of a pressure-sensitive adhesive sheet, a sheet-form resin sandwiched by transparent films is used. For example, the sheet-form resin is attached to the front plate, and then the sheet-form resin surface, attached to the front plate, is attached to the display surface.

The display panel includes a front plate of, for example, glass or plastic placed on the front surface of the display from the standpoint of protection of the display surface, crack prevention of large displays, and the design. The display panel also includes a touch panel for interactivity. That is, the front plate is formed from component(s) such as a glass plate, a plastic plate, and a touch panel. For example, a decorative front plate that is made of glass and provided with a patterned layer, consisting of a colored layer and a light-shielding layer, is also referred to as a decorative cover herein.

If the display panel is a liquid crystal display panel, transparent substrates (e.g., glass substrates) for the pair of substrates constituting the liquid crystal display panel each have a thickness of, typically, 0.15 to 1.0 mm.

The present invention also relates to a display device including the display panel with a front plate according to the present invention.

The suitable structure of the display panel with a front plate in the display device of the present invention is the same as the suitable structure of the display panel with a front plate according to the present invention described above.

Examples of such a display device include liquid crystal display devices, electroluminescence (EL) display devices, and plasma displays. Such a display device is suitable as medium-to-small-sized display devices for, for example, tablet PCs, cell phones and game machines. The display devices are also suitable as display devices which come readily equipped with a touch panel, such as smart phones. The other components are not particularly limited.

### Advantageous Effects of Invention

The display panel with a front plate and the display device of the present invention can exhibit suppressed peeling of the front plate, reduced air bubbles and display unevenness in and around the display region, and favorable display qualities.

### BRIEF DESCRIPTION OF DRAWINGS

FIG. 1 is a schematic cross-sectional view of a liquid crystal display panel with a front plate according to Embodiment 1.

FIG. 2 is a schematic plan view of the liquid crystal display panel with a front plate according to Embodiment 1.

FIG. 3 is another schematic cross-sectional view of a liquid crystal display panel with a front plate according to Embodiment 1.

FIG. 4 is a schematic cross-sectional view of a liquid crystal display panel with a front plate according to a modified example of Embodiment 1.

FIG. 5 is a schematic cross-sectional view of a liquid crystal display panel with a front plate according to Example 8.

FIG. 6 is a schematic cross-sectional view of a liquid crystal display panel with a front plate according to Example 9.

FIG. 7 is a schematic cross-sectional view of a conventional liquid crystal display panel with a front plate.

FIG. 8 is a schematic cross-sectional view of a liquid crystal display device with a front plate which is disclosed in Patent Literature 1.

### DESCRIPTION OF EMBODIMENTS

The present invention will be described in more detail below with reference to the drawings based on embodiments which, however, are not intended to limit the scope of the present invention. In the tables below, “OK” means “not remaining”, and “NG” means “remaining”.

### Embodiment 1

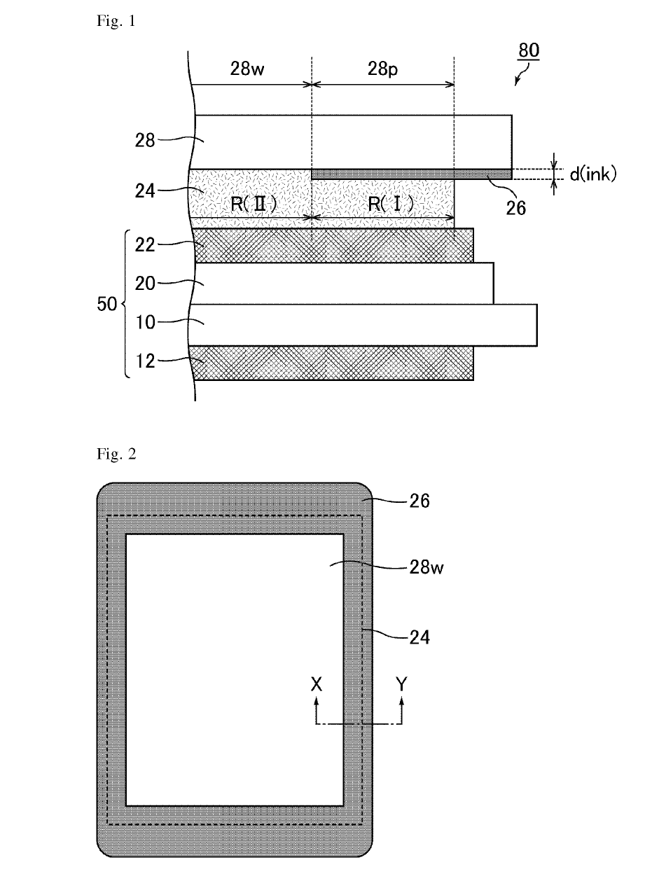

FIG. 1 is a schematic cross-sectional view of a liquid crystal display panel with a front plate according to Embodiment 1. FIG. 1 schematically illustrates a cross section along the X-Y line for the liquid crystal display panel with a front plate illustrated in FIG. 2 described later.

FIG. 1 illustrates a part of a display panel 80 with a front plate which includes a front plate 28 (decorative cover) disposed via an adhesive layer 24 formed from a pressure-sensitive adhesive (layer of a cured product of an ultraviolet-curable resin composition). The adhesive layer 24 is provided on a polarizing plate 22 disposed on the display-side (viewer-side) surface of the display panel. On the backside of the liquid crystal panel, a polarizing plate 12 and a backlight unit (not illustrated) are disposed in the stated order. The liquid crystal panel and the backlight unit can be bonded via a frame, for example.

The front plate 28 used was made of transparent tempered glass (thickness of 1 mm). The thickness of the front plate 28 can be, typically, from 0.4 mm to 3.0 mm inclusive.

The thickness of the adhesive layer 24 in the region R(II) corresponding to a window portion 28w was 125 μm. Usually, the thickness of the adhesive layer 24 corresponding to the window portion is preferably 50 to 250 μm. Particularly in the case of using the display panel for a mobile device such as a smart phone or a tablet which is desired to have a smaller thickness, then the thickness is preferably 175 μm or smaller.

The adhesive layer used was made of an acrylic-based pressure-sensitive adhesive curable by ultraviolet light. Here, the front plate and the display surface were bonded to each other via the resin composition, and the composition was cured through ultraviolet light irradiation.

In the case that the display panel is a liquid crystal display panel as in the present embodiment, the transparent substrates (e.g., glass substrates) constituting a pair of transparent electrode substrates 10 and 20 in the liquid crystal display panel each can have a thickness of, generally, 0.15 to 1.0 mm.

The pressure-sensitive adhesive used for the window portion 28w is preferably a material of which curing is promoted by ultraviolet irradiation. Examples thereof include materials curable by ultraviolet irradiation, such as acrylic-based pressure-sensitive adhesives and silicon-based pressure-sensitive adhesives.

In the present embodiment, the adhesive layer 24 has a lower elastic modulus in the region R(I) than in the region R(II).

The adhesive layer 24 preferably has an elastic modulus at 23° C. of 100 KPa or lower, more preferably 75 KPa or lower, and still more preferably 70 KPa or lower, in the region R(I).

In the region R(I) of the adhesive layer 24 which is under the printed layer, the pressure-sensitive adhesive is desired to deform to absorb the level difference of the total thickness of the color printed layer and light-shielding printed layer constituting the patterned layer. Hence, the adhesive layer 24 preferably has an elastic modulus of 100 KPa or lower, and more preferably 70 KPa or lower in the region R(I). That is, for the printed layer having a larger total thickness, the pressure-sensitive adhesive preferably has a lower elastic modulus in the region.

The adhesive layer 24 preferably has a degree of curing of 80% or higher, and more preferably 90% or higher in the region R(II). The upper limit for the degree of curing in the region R(I) of the adhesive layer 24 is preferably 70% or lower, and more preferably 60% or lower.

The degree of curing (elastic modulus) in the region R(II) of the adhesive layer 24, which is the same as that in the region R(I) of the pressure-sensitive adhesive, is increased to the desired level by uniformly irradiating only the entire region R(II) with ultraviolet light from the front plate 28 (decorative cover) side.

In the printed layer, one layer has a thickness of about 3 to 15 μm. The printed layer may be a single layer or a laminate of multiple printed layers (multi-layered print), but is preferably a laminate of multiple printed layers for favorable achievement of the effect of the present invention as described later.

Here, one layer of white print in color printing has a thickness of 12 μm. Bonding was performed also using printed materials having two, three, four, five, or six layers of white.

Although not illustrated, an antireflection film or an antifouling coat, for example, can be formed as needed on the front surface of the decorative cover (the surface of the decorative cover on the opposite side of the pressure-sensitive adhesive layer).

FIG. 2 is a schematic plan view of the liquid crystal display panel with a front plate according to Embodiment 1.

As illustrated in FIG. 2, a printed layer 26 is arranged to cover the periphery of the liquid crystal panel. The window portion 28w is surrounded by the printed layer 26. The pressure-sensitive adhesive layer 24 attached to the liquid crystal panel generally has a smaller size than the periphery of the liquid crystal panel.

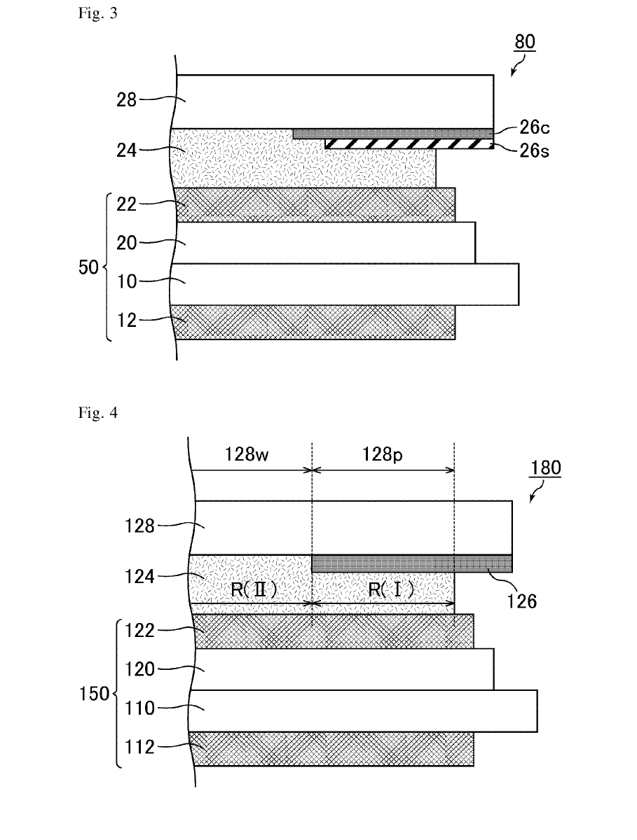

FIG. 3 is another schematic cross-sectional view of a liquid crystal display panel with a front plate according to Embodiment 1. FIG. 3 illustrates one example of a color printed layer 26c and a light-shielding printed layer 26s which constitute the printed layer 26.

### Examples 1 to 7

Each of the display devices of the present examples was produced through the following steps.

(1) The decorative cover and the liquid crystal display device were bonded to each other entirely via an entirely provided pressure-sensitive adhesive that has a given elastic modulus (degree of curing) in the region R(I) in each example. The bonding is preferably performed in vacuum (or under reduced pressure).

(2) After the bonding, treatments such as the autoclave treatment were performed as needed (e.g., treatment at 5 atm for 30 minutes, and heating as needed).

(3) The resulting product was irradiated with ultraviolet light from the decorative cover side such that the window portions are selectively irradiated with ultraviolet light. Thereby, the elastic modulus in the region R(II) was made high.

(4) The decorative cover was made to have six different print thicknesses, so that residual air bubbles in the level difference portions were determined under the certain pressure-sensitive adhesive thickness condition. As shown in Examples 1 to 5, bonding was successfully performed without residual air bubbles and display unevenness in the level difference portions if the inequality “thickness d(ink) of the patterned layer<thickness d(OCA) of the adhesive layer in the region not overlapping the patterned layer/2” held.

In contrast, air bubbles remained in the print level difference portions after the bonding in Example 6 where the inequality d(ink)<d(OCA)/2 failed to hold. In Example 7, the thickness of OCA was adjusted such that the above inequality would hold, and therefore the bonding was successfully performed without air bubbles. The above results show that it is preferred that the inequality d(ink)<d(OCA)/2 holds, where d(ink) indicates the thickness of the printed layer and d(OCA) indicates the thickness of the pressure-sensitive adhesive.

(5) Similarly, evaluation of air bubbles and peeling which could be caused by a decreased elastic modulus at high temperatures were performed. Here, no air bubbles or peeling occurred under any of the above conditions, and thus high reliability was achieved.

FIG. 4 is a schematic cross-sectional view of a liquid crystal display panel with a front plate according to a modified example of Embodiment 1. Even in the case of increasing the thickness d(ink) of the printed layer up to the thickness as illustrated in FIG. 4 with respect to the thickness d(OCA) of the pressure-sensitive adhesive, the effect of the present invention can be sufficiently achieved.

TABLE 1

| | Example 1 | Example 2 | Example 3 | Example 4 | Example 5 | Example 6 | Example 7 |
|---|---|---|---|---|---|---|---|
| Print thickness (number of | 12 μm | 25 μm | 35 μm | 50 μm | 60 μm | 73 μm | |
| layers) | (1 layer) | (2 layers) | (3 layers) | (4 layers) | (5 layers) | (6 layers) | |
| Thickness of pressure-sensitive | 125 μm | | | | | | 150 μm |
| adhesive | | | | | | | |
| Elastic modulus in region I | 38 KPa | | | | | | |
| (degree of curing) | (64%) | | | | | | |
| Elastic modulus in region II | 89 KPa | | | | | | |
| (degree of curing) | (>95%) | | | | | | |
| Air bubbles/display unevenness | OK | OK | OK | OK | OK | NG | OK |
| in level difference portion | | | | | | | |
| Air bubbles/peeling at 80° C. | OK | OK | OK | OK | OK | OK | OK |

Examples 3-1 to 3-4 in which the elastic moduli in the region (I) and the region (II) were changed from those in Example 3 (with a pressure-sensitive adhesive thickness of 125 μm and a print level difference of 35 μm) are shown in the following Table 2.

In Examples 3-1 to 3-4, the bonding was successfully performed without formation of residual air bubbles or display unevenness in the level difference portions. Similarly, evaluation of air bubbles and peeling which could be caused by a decreased elastic modulus at high temperatures were performed. Here, no air bubbles or peeling occurred under any of the above conditions, and thus high reliability was achieved.

TABLE 2

| | Example | Example | Example | Example |
|---|---|---|---|---|
| | 3-1 | 3-2 | 3-3 | 3-4 |
| Print thickness (number | 35 μm | | | |
| of layers) | (3 layers) | | | |
| Thickness of pressure- | 125 μm | | | |
| sensitive adhesive | | | | |
| Elastic modulus in re- | 38 KPa | 52 KPa | 68 KPa | 83 KPa |
| gion I (degree of curing) | (64%) | (73%) | (83%) | (93%) |
| Elastic modulus in re- | 89 KPa | | | |
| gion II (degree of curing) | (>95%) | | | |
| Air bubbles/display | OK | OK | OK | OK |
| unevenness in level | | | | |
| difference portion | | | | |
| Air bubbles/peeling at | OK | OK | OK | OK |
| 80° C. | | | | |

Examples 5-1 to 5-4 in which the elastic moduli in the region (I) and the region (II) were changed from those in Example 5 (with a pressure-sensitive adhesive thickness of 125 μm and a print level difference of 60 μm) are shown in the following Table 3.

In Examples 5-1 to 5-3 where the elastic modulus at 23° C. of the adhesive layer 24 in the region R(I) was 75 KPa or lower, the bonding was successfully performed without formation of residual air bubbles or display unevenness in the level difference portions. Similarly, evaluation of air bubbles and peeling which could be caused by a decreased elastic modulus at high temperatures were performed. Here, no air bubbles or peeling occurred under any of the above conditions, and thus high reliability was achieved.

In contrast, air bubbles remained in the print level difference portions after the bonding in Example 5-4 where the elastic modulus at 23° C. of the adhesive layer 24 in the region R(I) was higher than 75 KPa.

TABLE 3

| | Example | Example | Example | Example |
|---|---|---|---|---|
| | 5-1 | 5-2 | 5-3 | 5-4 |
| Print thickness (number | 60 μm | | | |
| of layers) | (5 layers) | | | |
| Thickness of pressure- | 125 μm | | | |
| sensitive adhesive | | | | |
| Elastic modulus in re- | 38 KPa | 52 KPa | 68 KPa | 83 KPa |
| gion I (degree of curing) | (64%) | (73%) | (83%) | (93%) |
| Elastic modulus in re- | 89 KPa | | | |
| gion II (degree of curing) | (>95%) | | | |
| Air bubbles/display | OK | OK | OK | NG |
| unevenness in level | | | | |
| difference portion | | | | |
| Air bubbles/peeling at | OK | OK | OK | OK |
| 80° C. | | | | |

In the present examples, a 4.3-inch quarter high definition (qHD) panel suitable for smart phones was used for the liquid crystal display devices.

In the present examples, the liquid crystal display devices each include a pair of polarizing plates and transparent electrode substrates, and may be in any liquid crystal display mode selected.

The display devices of the present examples may be any display devices other than liquid crystal display devices, such as organic EL display devices.

The display devices of the present examples may be in-cell touch-panel displays each of which has a touch panel function within the panel.

In this case, the durability against pressing pressure can be improved, and the thickness of the pressure-sensitive adhesive in the present invention can be made smaller than that of a common pressure-sensitive adhesive with respect to a given thickness of the printed cover. Hence, the distance between the cover surface to be touched by the finger and the detection surface of the touch panel can be made shorter. It will therefore be possible to detect touch operations at higher sensitivity than conventional display panels.

### Comparative Examples 1-1 to 4-1

Each module was formed in the same manner as the above processes (1) and (2).

The elastic moduli of the pressure-sensitive adhesive used here in the region R(I) and the region R(II) were both 85 KPa.

(3) The bonding was successfully performed without air bubbles in the level difference portions only in the case of a 12-μm printed layer, which was the thinnest of the four different thicknesses for the printed layer. The pressure-sensitive adhesives having any of the three other thicknesses which were thicker than 12 μm failed to conform to the level difference because of their inflexibility, and thus caused air bubbles to remain in the level difference portions.

(4) As to the evaluation at high temperatures, no new air bubbles formed other than the residual air bubbles observed in the process (3), but the residual air bubbles became bigger, decreasing the reliability.

TABLE 4

| | Compar- | Compar- | Compar- | Compar- |
|---|---|---|---|---|
| | ative | ative | ative | ative |
| | Example | Example | Example | Example |
| | 1-1 | 2-1 | 3-1 | 4-1 |
| Print thickness (number | 12 μm | 25 μm | 35 μm | 50 μm |
| of layers) | (1 layer) | (2 layers) | (3 layers) | (4 layers) |
| Thickness of pressure- | 150 μm | 150 μm | 150 μm | 150 μm |
| sensitive adhesive | | | | |
| Elastic modulus | 85 KPa | | | |
| Air bubbles/display | OK | NG | NG | NG |
| unevenness in level | | | | |
| difference portion | | | | |
| Air bubbles/peeling at | OK | OK | OK | OK |
| 80° C. | | | | |

### Comparative Examples 1-2 to 4-2

Each module was formed in the same manner as the above processes (1) and (2).

The elastic moduli of the pressure-sensitive adhesive used here in the region R(I) and the region R(II) were both 40 KPa.

(3) The decorative cover was made to have four different print thicknesses, so that residual air bubbles in the level difference portions were determined under the certain pressure-sensitive adhesive thickness condition. As a result, no air bubbles were observed, and the display qualities were favorable under any of the above conditions.

(4) The influence of a decrease in the elastic modulus at high temperatures was determined. Since the elastic modulus was already low at room temperature, the elastic modulus further decreased at high temperatures. Hence, new air bubbles formed in level difference portions in the case of three different print thicknesses other than a print thickness of 12 μm, and peeling of the cover from the end was observed.

In these comparative examples 1-1 to 4-1 and comparative examples 1-2 to 4-2, the degree of curing of the pressure-sensitive adhesive was already at the point of saturation (100%) before the attachment of the decorative cover. The high elastic modulus or low elastic modulus in the comparative examples was attributed to the molecular weight or degree of branching (degree of crosslinking) of the polymer constituting the pressure-sensitive adhesive, not to the degree of curing.

If the pressure-sensitive adhesive having a low elastic modulus (having a low degree of curing) was uniformly cured under the printed layer and in the window portion after the bonding, resilience of the pressure-sensitive adhesive under the printed layer particularly at high temperatures would be generated (since the pressure-sensitive adhesive has deformed to absorb the level difference, it would show a tendency to return to its original shape when heated). Hence, air bubbles are likely to generate in the edge portions of the print level differences. If the elastic modulus under the printed layer is low in the present invention, the resilience is smaller than that in the window portion, and therefore no air bubbles form.

TABLE 5

| | Compar- | Compar- | Compar- | Compar- |
|---|---|---|---|---|
| | ative | ative | ative | ative |
| | Example | Example | Example | Example |
| | 1-2 | 2-2 | 3-2 | 4-2 |
| Print thickness (number | 12 μm | 25 μm | 35 μm | 50 μm |
| of layers) | (1 layer) | (2 layers) | (3 layers) | (4 layers) |
| Thickness of pressure- | 150 μm | 150 μm | 150 μm | 150 μm |
| sensitive adhesive | | | | |
| Elastic modulus | 40 KPa | | | |
| Air bubbles/display | OK | OK | OK | OK |
| unevenness in level | | | | |
| difference portion | | | | |
| Air bubbles/peeling at | OK | NG | NG | NG |
| 80° C. | | | | |

### Embodiment 2

### Examples 8, 9

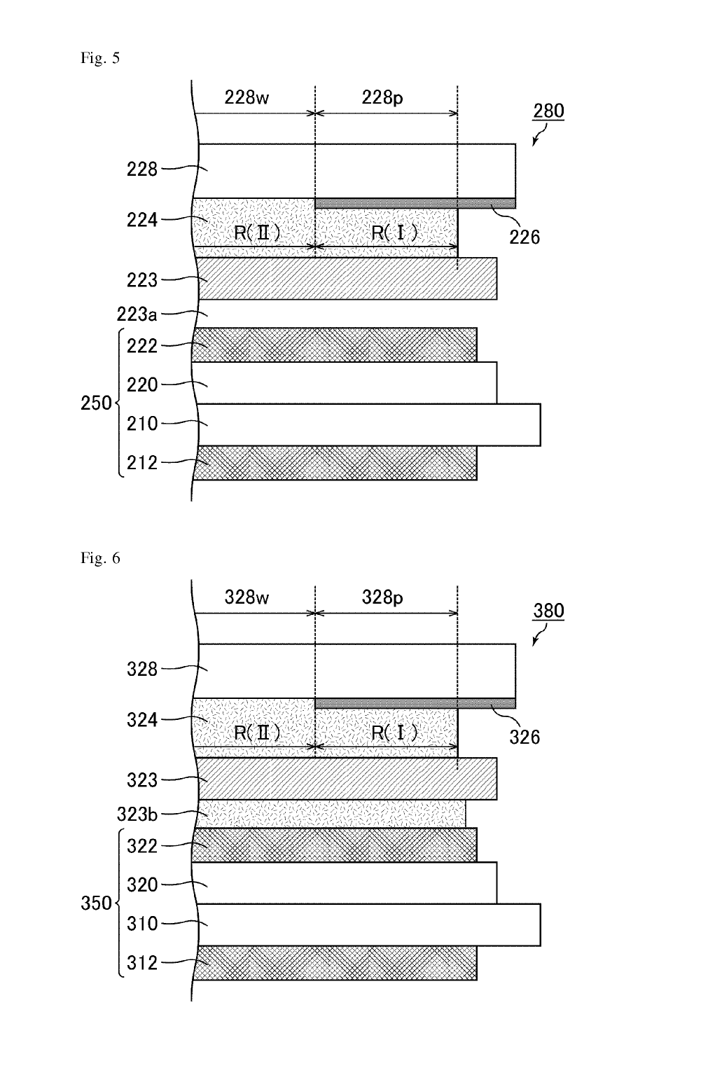

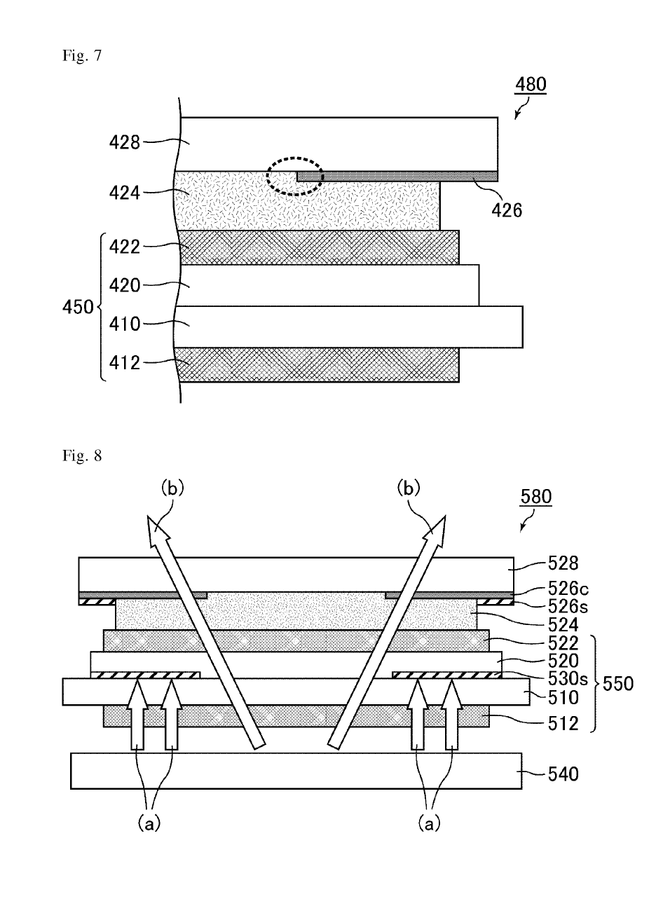

FIG. 5 is a schematic cross-sectional view of a liquid crystal display panel with a front plate according to Example 8.

FIG. 6 is a schematic cross-sectional view of the liquid crystal display panel with a front plate according to Example 9.

(1) In Examples 8 and 9, the decorative cover on which a printed layer was formed was attached entirely to a capacitive touch panel via a pressure-sensitive adhesive layer having different elastic moduli in the region R(I) and R(II).

(2) The capacitive touch panel includes a glass substrate or a plastic substrate formed from a resin, on which a predetermined electrode pattern is formed.

(3) The gap between the touch panel and the polarizing plate of the liquid crystal display device may be formed as an air layer 223a as in Example 8, or may be formed from a resin agent such as a pressure-sensitive adhesive or an adhesive as in Example 9 (for example, pressure-sensitive adhesive layer 323b).

The display panel with a front plate of the present invention can be verified by disassembling the liquid crystal display panel with a front plate, and measuring the degree of curing (FT-IR analysis) or elastic modulus of the pressure-sensitive adhesive. The elastic modulus in the present examples was determined by measuring the dynamic viscoelasticity at 25° C. and 1 Hz in accordance with JIS K7244-6. The measurement device used was a dynamic viscoelasticity measuring device (DVA-225 manufactured by IT Keisoku Seigyo K.K.).

The structure of the display panel with a front plate in the present examples may be, for example, a structure in which the front plate is a decorative cover, a structure in which the front plate is a touch panel, or a structure in which the front plate is a protective plate.

The present embodiments may be of display devices including the display panels with a front plate according to Embodiments 1 and 2. The display device may appropriately include components typically provided to display devices, such as a light source.

### REFERENCE SIGNS LIST

10, 20, 110, 120, 210, 220, 310, 320, 410, 420, 510, 520: transparent electrode substrate
12, 22, 112, 122, 212, 222, 312, 322, 412, 422, 512, 522: polarizing plate
24, 124, 224, 323b, 324, 424, 524: adhesive layer (pressure-sensitive adhesive layer)
26, 126, 226, 326, 426, 526: printed layer (patterned layer)
26c, 526c: color printed layer
26s, 526s: light-shielding printed layer
28, 128, 228, 328: front plate
28w, 128w, 228w, 328w, 428w, 528w: window portion
28p, 128p, 228p, 328p, 428p, 528p: printed region
50, 150, 250, 350, 450, 550: liquid crystal display panel
80, 180, 280, 380, 480, 580: display panel with front plate
223, 323: touch panel
223a: air layer
428: protective cover
528: decorative cover
530s: light-shielding portion
540: backlight unit
R(I), R(II): region

1. A display panel with a front plate, comprising:
a display panel;
a front plate;
an adhesive layer disposed between the front plate and the display panel; and
a patterned layer further disposed between the front plate and the display panel,
the adhesive layer partly overlapping the patterned layer in a plan view of a main surface of the display panel with a front plate,
a thickness of the adhesive layer in a region overlapping the patterned layer being smaller than a thickness of the adhesive layer in a region not overlapping the patterned layer,
the adhesive layer having a lower elastic modulus in the region overlapping the patterned layer than in the region not overlapping the patterned layer,
the patterned layer including a light-shielding layer.

2. The display panel with a front plate according to claim 1,
wherein when d(ink) indicates a thickness of the patterned layer and d(OCA) indicates the thickness of the adhesive layer in the region not overlapping the patterned layer, the following inequality holds:
d(ink)<d(OA)/2.

3. The display panel with a front plate according to claim 1,
wherein the thickness d(ink) of the patterned layer is 75 μm or smaller.

4. The display panel with a front plate according to claim 1,
wherein the thickness d(OCA) of the adhesive layer in the region not overlapping the patterned layer is 80 μm or greater.

5. The display panel with a front plate according to claim 1,
wherein the patterned layer is a laminate of the light-shielding layer and a colored layer.

6. The display panel with a front plate according to claim 1,
wherein the patterned layer is disposed in a part of the same layer as the adhesive layer.

7. The display panel with a front plate according to claim 6,
wherein the patterned layer is disposed on the front plate side in the same layer as the adhesive layer.

8. The display panel with a front plate according to claim 1,
wherein the patterned layer is a printed layer.

9. The display panel with a front plate according to claim 1,
wherein the adhesive layer is a cured product of an ultraviolet-curable resin composition.

10. The display panel with a front plate according to claim 9,
wherein the cured product has a degree of curing of 70% or lower in the region overlapping the patterned layer, and
the cured product has a degree of curing of 80% or higher in the region not overlapping the patterned layer.

11. The display panel with a front plate according to claim 1, the display panel with a front plate further comprising
a touch panel.

12. A display device comprising
the display panel with a front plate according to claim 1.
